(19) United States
(12) Patent Application Publication
(10) Pub. No.: US 2019/0388938 A1
(43) Pub. Date: Dec. 26, 2019

(54) CAMELLIA FRUIT SHELLING AND SORTING MACHINE

(71) Applicant: DONGGUAN UNIVERSITY OF TECHNOLOGY, Dongguan (CN)

(72) Inventors: Jun Deng, Dongguan (CN); Zhaoyang Lin, Dongguan (CN)

(21) Appl. No.: 16/286,550

(22) Filed: Feb. 26, 2019

(30) Foreign Application Priority Data
Jun. 25, 2018 (CN) 2018106591408
Dec. 26, 2018 (JP) 2018-243745

(51) Int. Cl. B07B 13/065; A23N 5/08; B07B 13/00; B07B 13/16

(52) U.S. Cl. CPC B07B 13/065; B07B 13/16; B07B 13/003; A23N 5/08

(57) ABSTRACT

The present invention relates to a camellia fruit shelling and sorting machine, including a sorting belt conveyance trough provided on a frame, the sorting belt conveyance trough is connected with a shelling mechanism through a sorting tank. The sorting belt conveyance trough is provided with a sorting tank, and a sorting guide block and a sorting separate block is provided within the sorting tank. A sorting sweeping block is placed in the inner top of the sorting tank, and the inner top of which is adjacent to the sorting conveyor. Spacing between the sorting sweep block and the sorting belt conveyance trough is greater than one camellia seed but less than two camellia seeds. The sorting separate block is provided with a sorting opening, and the sorting tank is embedded with a sorting push block. The sorting push block is connected with a sorting cylinder moved forwards and backwards on the frame, and the inner side of the sorting push block is embedded with a sorting beam emitter and is provided with a reflected beam receiver. The sorting beam emitter and the reflected beam receiver on the sorting push block of the present invention are used for detection of the camellia seeds, which may separate the inferior camellia seeds to realize the high-efficiency sorting of camellia seeds.

### FIELD OF THE INVENTION

The present invention relates generally to the field of processing equipment of camellia fruit, and more specifically, relates to a camellia fruit shelling and sorting machine.

### BACKGROUND OF THE INVENTION

The camellia fruit is an important agricultural product and crop with great economic value, and which has been widely promoted in Hunan Province, China.

The fruit of camellia includes shells and seeds, and seeds can be used for the refining of tea oil, which has high economic value. Thereby shelling the camellia fruit is necessary. Affected by the time of picking, some seeds after shelling are dark brown, some are yellow, and the dark brown camellia seeds are high in oil yield and good in oil quality. Due to the complexity of the sorting process and the heavy workload, the existing refinery of camellia seeds usually adopts mixed refining method without sorting of the camellia seeds. Therefore, it is urgent to design a shelling and sorting machine capable of completing the sorting of camellia seeds to improve the quality of the refining of the tea oil.

### SUMMARY OF THE INVENTION

The objective of the present invention is to provide a camellia fruit shelling and sorting machine, which uses a sorting guide block and a sorting sweep block in the sorting tank to match with a sorting belt conveyor, thereby achieving the one-by-one conveyance of camellia seeds. And the detection of the camellia seeds is realized through the matching of the sorting beam emitter and reflected beam receiver provided on the sorting push block. The sorting opening can separate the inferior camellia seeds, enabling efficient sorting of camellia seeds.

In order to achieve the above object, the technical solutions adopted by the present invention are:

A camellia fruit shelling and sorting machine including a frame, a shelling mechanism and a sorting device, which are matched with each other and are provided on the frame. The sorting device includes a sorting belt conveyance trough provided on the frame; the sorting belt conveyance trough is connected with the shelling mechanism through a sorting conveyor. The sorting belt conveyance trough is provided with a sorting tank that is fixedly attached to the frame and matched with the sorting conveyor. A side of the sorting tank matched with the sorting conveyance trough is provided with a sorting guide block, and the other side of which is provided with a sorting separate block subdivided by the sorting tank. The sorting tank are separated by the sorting separate block to form two sorting conveyance zones, and the width of the two sorting conveyance zones is greater than one camellia seed less than two camellia seeds. The inner top of the sorting tank is provided with a sorting sweep block and is adjacent to the sorting conveyor, and the spacing between the sorting sweep block and the sorting belt conveyance trough is greater than one camellia seed less than two camellia seeds. The sorting separate block is provided with a sorting opening, and the matching part of the sorting tank and the sorting opening is embedded with a sorting push block. The sorting push block is connected with a sorting cylinder provided on the frame, the sorting cylinder moves forwards and backwards on the frame, and a sorting beam emitter is embedded in the inside of the sorting push block. The inner side of the sorting push block is provided with a reflected beam receiver.

Further, the shelling mechanism includes a shelling conveyance trough and shelling cylinder provided on the frame, which are matched with each other. A shelling screw conveyance trough is provided within the shelling conveyance trough and is connected with a screw conveyance trough motor. The shelling cylinder is provided with a shelling rotary shaft moved forwards and backwards, and the shelling rotary shaft is connected with a shelling rotary motor. The shelling rotary shaft is sleeved with a shell rotary cylinder, the shell rotary cylinder is evenly sleeved with a shelling receive trough matched with the shelling conveyor. The lower part of the shelling cylinder is a sloped surface, and the lowest part of the sloped surface is provided with a shelling discharge opening. The shelling discharge opening is matched with a shell and seed separation device, and the sorting conveyance trough is matched with the shell and seed separation device.

Further, the inner cavity of the shelling conveyance trough is a cylindrical inner cavity and a square inner cavity communicating with each other, the shelling screw conveyance trough is provided within the cylindrical inner cavity, and the shelling receive trough is matched with the end of the square inner cavity. The square inner cavity is provided with a shelling and conveyance sweep block arranged vertically and moved forwards and backwards. The distance between the lower part of the shelling and conveyance sweep block and the inner bottom surface of the shelling conveyance trough is 1.2-1.5 times the diameter of the camellia fruit.

Further, the upper part of the shelling and conveyance sweep block passes through the shelling conveyance trough and is connected with a shelling and conveyance sweep lift block. The shelling and conveyance sweep lift block is connected with a vertically oriented shelling sweep lift cylinder provided on the upper part of the shelling conveyor. The side of the shelling and conveyance sweep block that is adjacent to the shelling cylinder is provided with a shelling push block, which is flush with the lower part of the shelling and conveyance sweep block.

Further, the upper part of the shelling conveyance trough is provided with a feeding cylinder connected with the shelling screw conveyor. The feeding cylinder is internally provided with an electro thermal block having the same shape thereof, the upper part of the feeding cylinder has a square column shape and a lower part of which has a square cone shape. And the front and rear distance of the lower opening thereof is consistent with the diameter of the cylindrical inner cavity of the shelling conveyor.

Further, the shell and seed separation device includes a shell and seed separation tank matched with the shelling discharge opening and the shell and seed separation tank is provided on the frame. The shell and seed separation tank is provided with two shell and seed separation shafts moved forwards and backwards and arranged side by side, the shell and seed separation shaft is connected with a shell and seed separation motor. The shell and seed separation rotary shaft is connected with a shell and seed separation net through a shell and seed separation connect block, and the mesh of the upper layer of the shell and seed separation net is 1.2 times the size of the camellia seed, and the mesh of the lower layer of the shell and seed separation net is 0.8 times the size of the camellia seed. The left and right ends of the shell and seed separation net are connected with a shell and seed separation elastic block. The shell and seed separation tank is provided with a shell and seed separation discharge opening respectively matched with the two shell and seed separation nets. The upper layer of the shell and seed separation discharge opening is matched with the shell collecting device provided on the frame through the shell conveyance chute, the lower layer of the shell and seed separation discharge opening is matched with the sorting conveyor.

Further, the lower part of the shell and seed separation tank is provided with a fragment discharge opening, and the fragment discharge opening is matched with a fragment discharge plug, the fragment discharge plug is installed in the lower part of the shell and seed separation tank through a discharge plug locking bolt. The bottom surface of the shell and seed separation tank is a slope with a high circumference and a low fragment discharge opening.

Further, the shell collecting device comprises a shell collecting tank disposed on the frame, the shell collecting tank is provided with a shell collecting bag. And the opening of the shell collecting bag is reversely folded in the upper part of the shell collecting tank and capped on the shell collecting tank through the shell collecting cap. The middle part of the shell collecting cap is an opening.

The beneficial effects of the invention are as follows:

The sorting guide block and the sorting sweep block in the sorting tank are matched with the sorting belt conveyance trough to realize the one by one conveyance of the camellia seeds, and is matched with sorting beam emitter and reflected beam receiver on sorting push block to realize the detection of the camellia seeds, and is matched with the sorting opening to realize separating inferior camellia seeds, thereby enabling efficient sorting of the camellia seeds. Cracked camellia fruit are thrown off downwardly and collapsing to shelling by using a rotatable shelling and receiving trough matching with a shelling conveyor. Compared with artificial shelling, the shelling efficiency is improved, and the damage of camellia seed is avoided, thereby the shelling effect is improved. The structure of the shelling conveyance trough makes it possible to ensure that the camellia fruit enters into the shelling and receiving trough in the form of single layer through the shelling and conveyance sweep block, thereby avoiding incomplete shelling of the camellia fruit due to the natural drop caused by the excessive entry of the camellia fruit at one time in the shelling and receiving trough.

The design of the shelling and conveyance sweep lift cylinder is capable of adjusting the height of the shelling and conveyance sweep block according to different specifications of the camellia fruit, thereby achieving a better sweeping effect. Simultaneously, with the design of the shelling press block the cracked camellia can be initially pressed and shelled, thereby the better shelling effect is achieve by matching with the rotary shell.

The design of the feeding cylinder and the electro thermal block therein is capable of realizing the heating and cracking of the camellia fruit during feeding process, thereby replacing the drying and cracking process. The structural design of the feeding cylinder is capable of ensuring that the camellia fruit have larger heating contact area, wherein the camellia fruit are about to enter the shelling conveyor.

The separation part of the shell and seed is simple in structure and ingenious in design. The separation can be achieved by using the separation net to rotate.

The design of the fragment discharge plug is capable of removing the crushed shells fallen into the bottom of the shell and seed separation tank easily.

The design of the shell collecting device is capable of collecting the shells of the camellia fruit in a bag, which is, convenient to operate.

### BRIEF DESCRIPTION OF THE DRAWINGS

FIG. 1 is a schematic view of a camellia fruit shelling and sorting machine;

FIG. 2 is a cross-sectional view taken along line F-F of FIG. 1;

FIG. 3 is a schematic view of the shelling mechanism;

FIG. 4 is a cross-sectional view taken along line A-A of FIG. 3;

FIG. 5 is a cross-sectional view taken along line B-B of FIG. 3;

FIG. 6 is a cross-sectional view of C in FIG. 3;

FIG. 7 is a cross-sectional view of D in FIG. 3; and

FIG. 8 is a schematic view of the shell collecting device.

### DETAILED DESCRIPTION OF THE ILLUSTRATED EMBODIMENT

The numbers shown in the FIGURES are marked as:
1. Frame;
2. Shelling conveyor;
3. Feeding cylinder;
4. Electro thermal block;
5. Shelling screw conveyor;
6. Screw conveyance trough motor;
7. Shelling and conveyance sweeping block;
8. Shelling and conveyance sweeping lift block;
9. Shelling and sweeping lift cylinder;
10. Shelling press block;
11. Shelling cylinder;
12. Shelling rotary shaft;
13. Shelling rotary cylinder;
14. Shelling and receiving trough;
15. Shelling discharge opening;
16. Shell and seed separation tank;
17. Shell and seed separation rotary shaft;
18. Shell and seed separation connect block;
19. Shell and seed separation net;
20. Shell and seed separation elastic block;
21. Fragments discharge plug;
22. Discharge plug locking bolt;
23. Shell and seed separation discharge opening;
24. Shell conveyance chute;
25. Sorting device;
26. Shell collecting device;
27. Seed collecting slide;
28. Seed collecting tank;
32. Shell collecting tank;
33. Shell collecting bag;
34. Shell collecting cap;
47. Shelling device;
61. Sorting conveyor;
62. Sorting belt conveyor;
63. Sorting tank;
64. Sorting separate block;
65. Sorting opening;
66. Sorting sweep block;
67. Sorting guide block;
68. Sorting cylinder
69. Sorting push block
70. Sorting beam emitter_{∘}

The present invention will be described in detail below with reference to the accompanying drawings, and the description of the present invention is only exemplary and explanatory, and should not be construed as limiting the scope of the present invention.

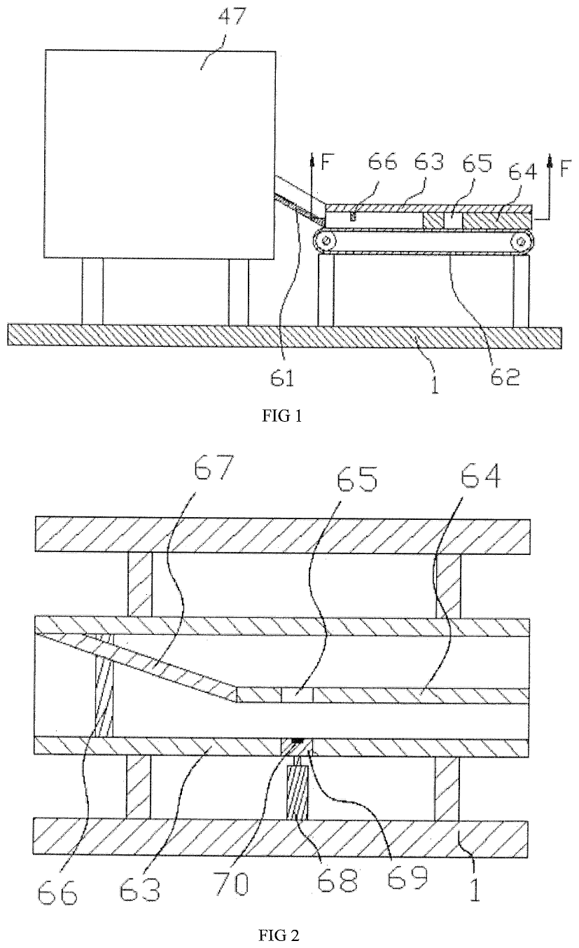

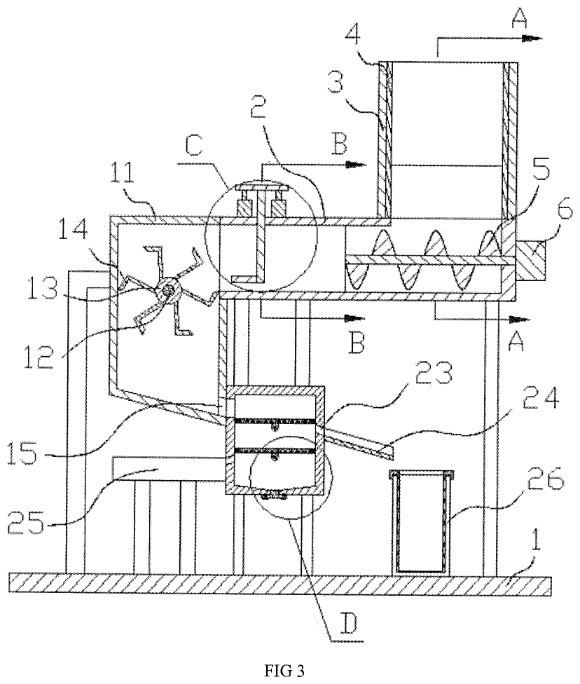

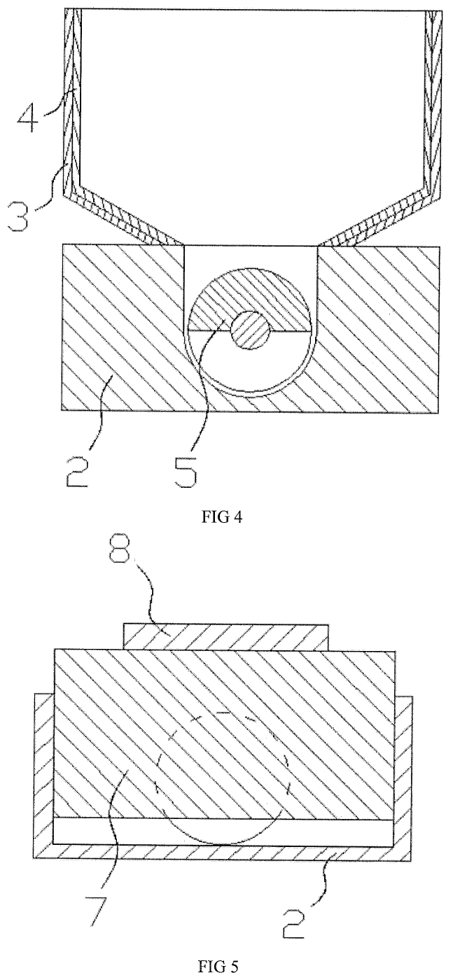

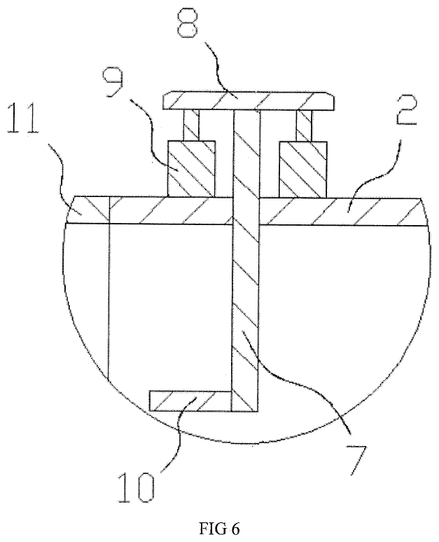

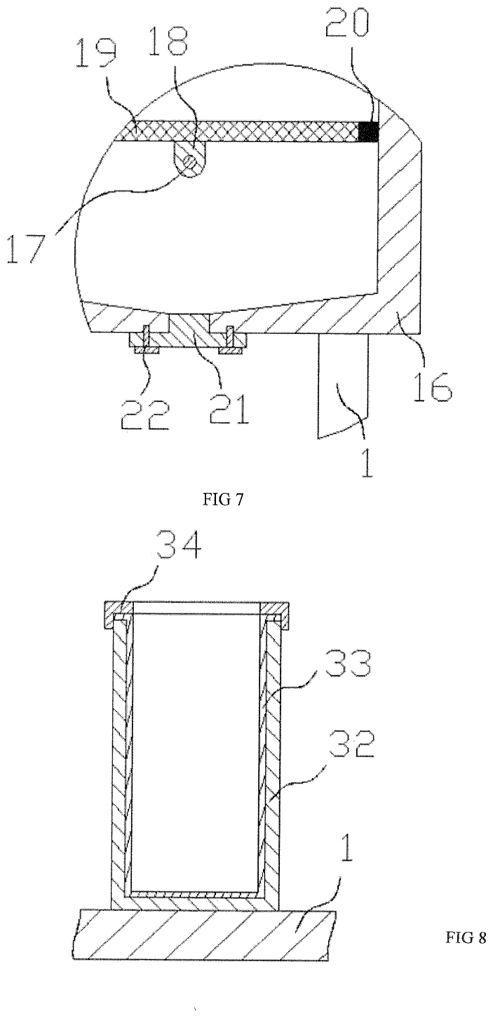

As shown in FIGS. 1-8, the specific structure of the present invention is: A camellia fruit shelling and sorting machine, including a frame 1 provided with a shelling mechanism 47 and a sorting device 25 matched with each other. The sorting device 25 includes a sorting belt conveyance trough 62 provided on the frame 1. The sorting belt conveyance trough 62 is connected with the shelling mechanism 47 by a sorting conveyance trough 61, and a sorting tank 63 is disposed thereon. The sorting tank 63 is fixedly connected with the frame 1 and is matched with a sorting conveyance trough 61. A side of the sorting tank 63 that matches with the sorting conveyance trough 61 is provided with a sorting guide block 67 and the other side of which is provided with a sorting separate block 64 that is equally divided by two sorting tanks 63. And the sorting conveyance trough 61 is separated by the sorting separate block 64 to form two sorting conveyance zones having a width greater than one camellia seed less than two camellia seeds. A sorting sweep block 66 is disposed on the inner top of the sorting tank 63, and which is adjacent to the sorting conveyance trough 61. The spacing between the sorting sweep block 66 and the sorting belt conveyance trough 62 is greater than one camellia seed less than two camellia seeds. The sorting separate block 64 is provided with a sorting opening 65, a sorting push block 69 is embedded in the part of the sorting tank 63 matching with the sorting opening 65. The sorting push block 69 is connected with a sorting cylinder 68 moved forwards and backwards disposed on the frame 1; the inner side of the sorting push block 69 is embedded with a sorting beam emitter 70 and is provided with a reflected beam receiver.

Preferably, the shelling mechanism 47 includes shelling conveyance trough 2 and shelling cylinder 11 provided on the frame 1 matched with each other. A shelling screw conveyance trough 5 is provided within the shelling conveyance trough 2 and is connected with a screw conveyance trough motor 6. A shelling rotary shaft 12 moved forwards and backwards is provided on the shelling cylinder 11 and is connected with a shelling rotary motor. The shelling rotary shaft 12 is sleeved with a shell rotary cylinder 13, which is evenly sleeved with a shelling and receiving trough 14 matched with the shelling conveyance trough 2. The lower part of the shelling cylinder 11 is a sloped surface, and the bottom of the sloped surface is provided with a shelling discharge opening 15, the shelling discharge opening 15 is matched with a shell and seed separation device, the sorting conveyance trough 61 is matched with the shell and seed separation device.

Preferably, the inner cavity of the shelling conveyance trough 2 is a cylindrical inner cavity and a square inner cavity communicating with each other. The shelling screw conveyance trough 5 is provided within the cylindrical inner cavity, the shelling and receiving trough 14 is matched with the end of the square inner cavity, and a vertically arranged shelling and conveyance sweep block 7 is provided within the square inner cavity that moved forwards and backwards. The distance between the lower part of the shelling and conveyance sweep block 7 and the inner bottom surface of the shelling conveyance trough 2 is 1.2-1.5 times the diameter of the camellia fruit.

Preferably, the upper part of the shelling and conveyance sweep block 7 passes through the shelling conveyance trough 2 and is connected with a shelling and conveyance sweep lift block 8. The shelling and conveyance sweep lift block 8 is connected with a vertically oriented shelling and sweeping lift cylinder 9 provided on the shelling conveyance trough 2. A side of the shelling and conveyance sweep block 7 adjacent to the shelling cylinder 11 is provided with a shelling press block 10, the shelling press block 10 is on the same level with the lower part of the shelling and conveyance sweep block 7.

Preferably, the upper part of the shelling conveyance trough 2 is provided with a feeding cylinder 3 connected with the shelling screw conveyance trough 5, the feeding cylinder 3 is internally provided with an electro thermal block 4 having a shape consistent with the same. The upper part of the feeding cylinder 3 has a square column shape and a lower part of which has a square cone shape, and the front and rear distance of the lower opening thereof is the same as the diameter of the cylindrical inner cavity of the shelling conveyance trough 2.

Preferably, the shell and seed separation device comprises a shell and seed separation tank 16 disposed on the frame 1 and matched with the shelling discharge opening 15. The shell and seed separation tank 16 is provided with two shell and seed separation shafts 17 moved forwards and backwards, which are arranged side by side. The shell and seed separation shaft 17 is connected with a shell and seed separation motor, and is connected with a shell and seed separation net 19 through a shell and seed separation connect block 18. The mesh of the upper layer of the shell and seed separation net 19 is 1.2 times the size of the camellia seed, and the mesh of the lower layer of the shell and seed separation net 19 is 0.8 times the size of the camellia seed. The left and right ends of the shell and seed separation net 19 are connected with a shell and seed separation elastic block 20, the shell and seed separation tank 16 is provided with a shell and seed separation discharge opening 23 respectively matched with the two layers of the shell and seed separation nets 19. The upper part of the shell and seed separation discharge opening 23 is matched with a shell collecting device 26 provided on the frame 1 through a shell conveyance chute 24, and the lower part of the shell and seed separation discharge opening 23 is matched with the sorting conveyance trough 61.

Preferably, the shell and seed separation tank 16 has a fragment discharge opening at a lower part thereof, and the fragment discharge opening is matched with a fragment discharge plug 21. The fragment discharge plug 21 is installed in the lower part of the shell and seed separation tank 16 through a discharge plug locking bolt 22, the bottom surface of the shell and seed separation tank 16 is a chute with a high circumference and a low fragment discharge opening.

Preferably, the shell collecting device 26 includes a shell collecting tank 32 disposed on the frame 1, and the shell collecting tank 32 is provided with a shell collecting bag 33. The opening of the shell collecting bag 33 is folded reversely in the upper part of the shell collecting tank 32 and is capped on the shell collecting tank 32 through a shell collecting cap 34. The middle part of the shell collecting cap 34 is an opening.

When in specific use, at first, place the to be shelled camellia fruit in the feeding cylinder 3, and then the camellia fruit is heated by the electro thermal block 4 in the feeding cylinder 3, and after heating for a certain period of time, the camellia fruit is cracked. The shelling screw conveyance trough 5 is driven by the screw conveyance trough motor 6, and then the camellia fruit is fed into the square cavity of the shelling conveyance trough 2 by the shelling screw conveyance trough 5. When the camellia fruit passes the shelling and conveyance sweep block 7 in the shelling conveyance trough 2, the shelling and conveyance sweep block 7 intercepts the stacked camellia fruit to ensure that there is only one layer of camellia fruit passing through. After that, the shelling press block 10 is driven by the shelling and sweeping lift cylinder 9 to press the camellia fruit passing through the shelling and conveyance sweep block 7 to carry out the pre-sequencing pressing and shelling operation. After that, the camellia fruit will fall from the outlet end of the shelling conveyance trough 2 into the shelling and receiving trough 14, and the shelling and receiving trough 14 is rotated by the shelling rotary motor. After the shelling and receiving trough 14 rotary for a certain angle, the camellia fruit will be dropped into the lower part of the shelling cylinder 11 and the shell process is finished by impact.

The shelled seeds and shells will enter the shell and seed separation tank 16, first, they fall onto the upper layer of shell and seed separation net 19, the shell and seed separation net 19 is rotated by the shell and seed separation motor, then the cracked shells and seeds are dropped onto the lower layer of shell and seed separation net 19. Meanwhile, the shells remaining in the upper layer enter the shell conveyance chute 24 through the shell and seed separation discharge opening 23, and then enter the shell collecting bag 33. The lower layer of shell and seed separation net 19 operates in accordance with the upper layer, the fragments fall into the bottom of the shell and seed separation tank 16, and the seeds enter the sorting conveyance trough 61, when the fragments reach a certain amount, they are taken out by removing the fragments discharge plug 21, When the shell in the shell collecting bag 33 reach a certain amount, the shell collecting cap 34 is opened to take out the shell collecting bag 33, and then the new shell collecting bag 33 is replaced. The camellia seeds entering the sorting conveyance trough 61 will then enter the sorting belt conveyance trough 62 below the sorting tank 63. The conveyance of the sorting belt conveyance trough 62 in conjunction with the sorting guide block 67 and the sorting sweep block 66 ensures that the camellia seeds enter one by one into a sorting transport zone separated by the sorting divider block 64. The conveyance of the camellia seeds will be stopped while passing through the sorting beam emitter 70. If the reflected beam receiver does not receive the reflected signal, the conveyance of the sorting belt conveyance trough 62 continues, if the reflected beam receiver receives the reflected signal, the sorting push block 69 is driven by the sorting cylinder 68 to push the camellia seeds from the sorting opening 65 to another sorting conveyance zone. Then the conveyance of the sorting belt conveyance trough 62 is continued, and so on until all of the shelling is complete.

It should be noted that in the present invention, the terms “including”, “comprising”, or any other variant thereof are intended to cover a non-exclusive inclusion, thereafter a process, method, item, or device that comprises a plurality of elements includes not only those elements but also other elements that are not listed, or elements that are inherent to the above process, method, item, or device.

The principles and embodiments of the present invention have been described in detail herein by using specific examples. The description of the above embodiments is only to assist in understanding the method of the present invention and its core ideas. The above description is only a preferred embodiment of the present invention, and it should be noted that due to the finiteness of the expression of words, there is an infinite concrete structure objectively. It will be apparent to those skilled in the art that improvements, modifications or variations may be made without departing from the principles of the invention, and the technical features described above may be combined in an appropriate manner. These improvements, modifications, or combinations, or the direct application of the inventive concepts and technical solutions to other applications without modification, are considered to be within the scope of the present invention.

What is claimed is:

1. A camellia fruit shelling and sorting machine, including a frame 1 provided with a shelling mechanism 47 and a sorting device 25 matched with each other, wherein the sorting device 25 includes a sorting belt conveyance trough 62 provided on the frame 1. The sorting belt conveyance trough 62 is connected with the shelling mechanism 47 by a sorting conveyance trough 61, and a sorting tank 63 is disposed thereon. The sorting tank 63 is fixedly connected with the frame 1 and is matched with a sorting conveyance trough 61. A side of the sorting tank 63 that matches with the sorting conveyance trough 61 is provided with a sorting guide block 67 and the other side of which is provided with a sorting separate block 64 that is equally divided by two sorting tanks 63. The sorting conveyance trough 61 is separated by the sorting separate block 64 to form two sorting conveyance zones having a width greater than one camellia seed less than two camellia seeds. A sorting sweep block 66 is disposed on the inner top of the sorting tank 63, and which is adjacent to the sorting conveyance trough 61. The spacing between the sorting sweep block 66 and the sorting belt conveyance trough 62 is greater than one camellia seed less than two camellia seeds. The sorting separate block 64 is provided with a sorting opening 65, a sorting push block 69 is embedded in the part of the sorting tank 63 matching with the sorting opening 65. The sorting push block 69 is connected with a sorting cylinder 68 moved forwards and backwards disposed on the frame 1; the inner side of the sorting push block 69 is embedded with a sorting beam emitter 70 and is provided with a reflected beam receiver.

2. The camellia fruit shelling and sorting machine according to claim 1, wherein the shelling mechanism 47 includes shelling conveyance trough 2 and shelling cylinder 11 provided on the frame 1 matched with each other. A shelling screw conveyance trough 5 is provided within the shelling conveyance trough 2 and is connected with a screw conveyance trough motor 6. A shelling rotary shaft 12 moved forwards and backwards is provided on the shelling cylinder 11 and is connected with a shelling rotary motor. The shelling rotary shaft 12 is sleeved with a shell rotary cylinder 13, which is evenly sleeved with a shelling and receiving trough 14 matched with the shelling conveyance trough 2. The lower part of the shelling cylinder 11 is a sloped surface, and the bottom of the sloped surface is provided with a shelling discharge opening 15, the shelling discharge opening 15 is matched with a shell and seed separation device, the sorting conveyance trough 61 is matched with the shell and seed separation device.

3. The camellia fruit shelling and sorting machine according to claim 2, wherein the inner cavity of the shelling conveyance trough 2 is a cylindrical inner cavity and a square inner cavity communicating with each other. The shelling screw conveyance trough 5 is provided within the cylindrical inner cavity, the shelling and receiving trough 14 is matched with the end of the square inner cavity, and a vertically arranged shelling and conveyance sweep block 7 is provided within the square inner cavity that moved forwards and backwards. The distance between the lower part of the shelling and conveyance sweep block 7 and the inner bottom surface of the shelling conveyance trough 2 is 1.2-1.5 times the diameter of the camellia fruit.

4. The camellia fruit shelling and sorting machine according to claim 3, wherein the upper part of the shelling and conveyance sweep block 7 passes through the shelling conveyance trough 2 and is connected with a shelling and conveyance sweep lift block 8. The shelling and conveyance sweep lift block 8 is connected with a vertically oriented shelling and sweeping lift cylinder 9 provided on the shelling conveyance trough 2. A side of the shelling and conveyance sweep block 7 adjacent to the shelling cylinder 11 is provided with a shelling press block 10, the shelling press block 10 is on the same level with the lower part of the shelling and conveyance sweep block 7.

5. The camellia fruit shelling and sorting machine according to claim 3, wherein the upper part of the shelling conveyance trough 2 is provided with a feeding cylinder 3 connected with the shelling screw conveyance trough 5, the feeding cylinder 3 is internally provided with an electro thermal block 4 having a shape consistent with the same. The upper part of the feeding cylinder 3 has a square column shape and a lower part of which has a square cone shape, and the front and rear distance of the lower opening thereof is the same as the diameter of the cylindrical inner cavity of the shelling conveyance trough 2.

6. The camellia fruit shelling and sorting machine according to claim 2, wherein the shell and seed separation device comprises a shell and seed separation tank 16 disposed on the frame 1 and matched with the shelling discharge opening 15. The shell and seed separation tank 16 is provided with two shell and seed separation shafts 17 moved forwards and backwards, which are arranged side by side. The shell and seed separation shaft 17 is connected with a shell and seed separation motor, and is connected with a shell and seed separation net 19 through a shell and seed separation connect block 18. The mesh size of the upper layer of the shell and seed separation net 19 is 9.6-12 mm and the mesh size of the lower layer of the shell and seed separation net 19 is 6.4-8 mm. The left and right ends of the shell and seed separation net 19 are connected with a shell and seed separation elastic block 20, the shell and seed separation tank 16 is provided with a shell and seed separation discharge opening 23 respectively matching with the two layers of the shell and seed separation nets 19. The upper part of the shell and seed separation discharge opening 23 is matched with a shell collecting device 26 provided on the frame 1 through a shell conveyance chute 24, and the lower part of the shell and seed separation discharge opening 23 is matched with the sorting conveyance trough 61.

7. The camellia fruit shelling and sorting machine according to claim 6, wherein the shell and seed separation tank 16 has a fragment discharge opening at a lower part thereof, and the fragment discharge opening is matched with a fragment discharge plug 21. The fragment discharge plug 21 is installed in the lower part of the shell and seed separation tank 16 through a discharge plug locking bolt 22, the bottom surface of the shell and seed separation tank 16 is a chute with a high circumference and a low fragment discharge opening.

8. The camellia fruit shelling and sorting machine according to claim 6, wherein the shell collecting device 26 includes a shell collecting tank 32 disposed on the frame 1, and the shell collecting tank 32 is provided with a shell collecting bag 33. The opening of the shell collecting bag 33 is folded reversely in the upper part of the shell collecting tank 32 and is capped on the shell collecting tank 32 through a shell collecting cap 34. The middle part of the shell collecting cap 34 is an opening.
